(19) United States
(12) Patent Application Publication
(10) Pub. No.: US 2026/0275953 A1
(43) Pub. Date: Sep. 17, 2026

(54) WAVE ENERGY EXTRACTION SYSTEMS AND METHODS INCLUDING FLOATING WAVE ENERGY CONVERTERS

(71) Applicant: University of Houston System, Houston, TX (US)

(72) Inventors: Dimitrios Kalliontzis, Manvel, TX (US); Stergios Liapis, Bellaire, TX (US)

(73) Assignee: University of Houston System, Houston, TX (US)

(21) Appl. No.: 19/569,633

(22) Filed: Mar. 17, 2026

Related U.S. Application Data
(60) Provisional application No. 63/773,139, filed on Mar. 17, 2025.

(51) Int. Cl. F03B 13/14

(52) U.S. Cl. CPC F03B 13/14; F05B 2240/93

(57) ABSTRACT

A floating wave energy converter (WEC) includes a floating housing defined by an interior, a fluid channel positioned in the interior and configured to hold a working fluid, and a turbine positioned along the fluid channel to contact the working fluid when the working fluid is held in the fluid channel, and wherein in response to a movement in a water column external the WEC, motion is induced in the working fluid to operate the turbine and generate electrical energy.

### CROSS-REFERENCE TO RELATED APPLICATIONS

This application claims benefit of U.S. provisional patent application Ser. No. 63/773,139 filed Mar. 17, 2025, and entitled “Wave Energy Extraction Systems and Methods Including Floating Wave Energy Converters,” which is hereby incorporated herein by reference in its entirety for all purposes.

### STATEMENT REGARDING FEDERALLY SPONSORED RESEARCH OR DEVELOPMENT

Not applicable.

### BACKGROUND

Wave energy converters (WECs) are devices that convert wave energy into electrical energy that may be subsequently used for a variety of purposes. Particularly, wave energy refers to the mechanical energy carried by surface waves of large bodies of water primarily generated by the wind as it blows across a body of water. The rising, falling, and surging motion of the water contains both extractable kinetic and potential energy. By placing WECs in areas of strong wave action, it is possible to harness this kinetic and potential energy carried by surface waves and transform it into electrical energy or power. Additionally, wave energy is considered a renewable resource because it is continually replenished by natural processes, making it an attractive option for sustainable power generation.

### SUMMARY

An embodiment of a floating WEC comprises a floating housing defined by an interior, a fluid channel positioned in the interior and configured to hold a working fluid, and a turbine positioned along the fluid channel to contact the working fluid when the working fluid is held in the fluid channel, and wherein in response to a movement in a water column external the WEC, motion is induced in the working fluid to operate the turbine and generate electrical energy. In some embodiments, the fluid channel is sealed from the water column. In some embodiments, the fluid channel comprises a plurality of vertical channels extending between a vertically upper end and a longitudinally opposed vertically lower end, and a horizontal channel fluidically connecting the plurality of vertical channels. In certain embodiments, the working fluid is allowed to flow between the plurality of vertical channels in multiple directions. In certain embodiments, the plurality of vertical channels are configured to induce a back-and-forth flow of the working fluid through the horizontal channel in response to rotation of the WEC about a pivot axis. In some embodiments, a natural frequency of the floating housing is configured to align with a natural frequency of the water column. In some embodiments, the housing comprises a hemispherical or an ellipsoidal lower surface. In certain embodiments, the housing comprises a convex lower surface. In certain embodiments, the fluid channel comprises a first pair of vertical channels, a first horizontal channel fluidically connected between the first pair of parallel vertical channels, a second pair of vertical channels, and a second horizontal channel fluidically connected between the second pair of parallel vertical channels and extending orthogonal to the first horizontal channel such that the second horizontal channel intersects the first horizontal channel. In some embodiments, the WEC comprises a pivot connector, a first connector member pivotably connecting the housing to the pivot connector whereby the WEC is pivotable about a first pivot axis defined by the pivot connector, and a second connector member pivotably connecting the housing to the pivot connector whereby the WEC is pivotable about a second pivot axis defined by the pivot connector that extends orthogonal to the first pivot axis.

An embodiment of a system for wave energy extraction comprises a floating WEC comprising a floating housing defined by an interior, a fluid channel positioned in the interior and configured to hold a working fluid, a turbine positioned along the fluid channel and in contact with the working fluid when the working fluid is held by the fluid channel, wherein the turbine is configured to generate electrical energy in response to flow of the working fluid through the fluid channel driven by pivoting of the WEC about a pivot axis, and a mounting assembly configured to couple the WEC to a marine structure. In some embodiments, the mounting assembly comprises one or more support arms pivotably connected to the housing by a pivot connector whereby the WEC is rigidly secured to the marine structure while allowing the WEC to rotate about a pivot axis of the pivot connector. In certain embodiments, the fluid channel comprises a pair of parallel vertical channels extending between a vertically upper end and a longitudinally opposed vertically lower end, and a horizontal channel fluidically connecting the pair of vertical channels. In certain embodiments, the mounting assembly comprises a linear actuator configured to transport the WEC between a deployed position and a retracted position that is vertically spaced from the deployed position. In some embodiments, the mounting assembly comprises a vertical rail, an elevator transportable along the rail, and a mount coupled between the WEC and the elevator. In some embodiments, the system comprises a linear actuator configured to transport the elevator vertically along the rail, and a system controller comprising one or more processors and a memory device encoded with instructions that, when executed by the one or more processors, cause the one or more processors to operate the linear actuator to transport the WEC between a deployed position and a retracted position that is vertically spaced from the deployed position. In certain embodiments, the elevator comprises a locking pin actuatable between a retracted position permitting relative movement between the rail and the elevator and an extended position locking the elevator to the rail.

An embodiment of a method for wave energy extraction comprises (a) coupling a mounting assembly to a WEC, the WEC comprising a floating housing defined by an interior, wherein a fluid channel having a working fluid is positioned in the interior, (b) coupling the mounting assembly to a marine structure whereby the WEC is coupled to the marine structure by the mounting assembly, and (c) deploying the WEC to a waterline of a water column whereby the WEC converts kinetic energy of moving water in the water column to electrical energy based on flow of the working fluid in the fluid channel in response to pivoting of the WEC induced by motion of the water column. In certain embodiments, the mounting assembly is pivotably connected to the housing by a pivot joint permitting the housing to rotate about a pivot axis of the pivot joint. In some embodiments, the WEC is pivotably coupled to the marine structure by the mounting assembly whereby the WEC is pivotable about both a first pivot axis and a second pivot axis that extends orthogonal to the first pivot axis. In some embodiments, the method comprises (d) transporting the WEC vertically by the mounting assembly, in response to changing environmental and operational conditions. In certain embodiments, the method comprises (d) vertically transporting the WEC by the mounting assembly between a deployed position at the waterline and a retracted position located vertically above the waterline and spaced from the deployed position.

### BRIEF DESCRIPTION OF THE DRAWINGS

For a detailed description of various exemplary embodiments, reference will now be made to the accompanying drawings in which:

FIG. 1 is a schematic representation of an embodiment of a wave energy extraction system in accordance with principles disclosed herein;

FIG. 2 is a schematic representation of another exemplary embodiment of a mounting assembly of the wave energy extraction system of FIG. 1 in accordance with principles disclosed herein;

FIG. 3 is a schematic representation of yet another exemplary embodiment of the mounting assembly of the wave energy extraction system of FIG. 1 in accordance with principles disclosed herein;

FIG. 4 is a schematic representation of another embodiment of a wave energy extraction system in accordance with principles disclosed herein;

FIG. 5 is a schematic representation of another embodiment of a wave energy extraction system in accordance with principles disclosed herein;

FIG. 6 is a schematic representation of yet another embodiment of a wave energy extraction system in accordance with principles disclosed herein;

FIG. 7 is a perspective view of yet another embodiment of a wave energy extraction system in accordance with principles disclosed herein;

FIG. 8 is a zoomed-in perspective view of the wave energy extraction system of FIG. 7;

FIG. 9 is a partial, zoomed-in perspective view of the wave energy extraction system of FIG. 7;

FIGS. 10 and 11 are additional perspective views of the wave energy extraction system of FIG. 7;

FIG. 12 is a schematic representation of another exemplary embodiment of the floating wave energy converter of FIG. 1 in accordance with principles disclosed herein;

FIG. 13 is a schematic diagram of an exemplary turbine of the floating wave energy converter of FIG. 12 in accordance with principles disclosed herein;

FIGS. 14-16 are schematic diagrams illustrating operation of the floating wave energy converter of FIG. 12 in accordance with principles disclosed herein;

FIG. 17 is a schematic representation of yet another exemplary embodiment of the floating wave energy converter of FIG. 1 in accordance with principles disclosed herein;

FIG. 18 is a schematic representation of yet another exemplary embodiment of the floating wave energy converter of FIG. 1 in accordance with principles disclosed herein;

FIG. 19 is a block diagram of an embodiment of a computer system in accordance with principles disclosed herein; and

FIG. 20 is a flowchart illustrating an embodiment of a method for wave energy extraction in accordance with principles disclosed herein.

### DESCRIPTION OF THE DISCLOSED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Further, as used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, WECs are devices positioned in areas of strong wave action for converting wave energy carried by the wave action into electrical power. Typically, WECs include a prime mover in the form of a buoy or floater that captures the motion of the waves, a power take-off (PTO) system including an electrical generator that converts this captured motion into electrical power, and a foundation and mooring arrangement that keeps the device properly oriented and secure in the marine environment. The prime mover's oscillation due to incoming waves drives the electrical generator of the PTO system to thereby convert kinetic and/or potential energy from the waves into usable electrical power.

Conventional WECs typically include a dedicated foundation and mooring system for keeping the WEC properly positioned and secure amid the dynamic conditions of the marine environment. Several approaches to foundations and mooring designs exist, dictated by factors such as water depth, seabed conditions, wave climate, and the specifics of the WEC. For instance, in shallower regions or where the seabed is suitably composed, seabed-mounted foundations can be employed which include gravity-based foundations, which are large, heavy structures that rely on their mass for stability; piled foundations, involving steel piles that are driven or drilled into the seabed; and suction caissons, which rely on pressure differentials to embed them firmly in place. Alternatively, in deeper waters, mooring systems are more common. For example, catenary moorings use slack chains or cables extending from the WEC down to seabed anchors, relying on the weight of the chain and anchor system to keep devices in place, while taut-leg moorings incorporate lines under tension to restrict device movement. Hybrid systems may combine features of both catenary and taut moorings.

In some instances, to construct these foundations and mooring systems of conventional WECs, anchors or foundation structures (often steel or concrete) are fabricated onshore and then transported offshore, where specialized vessels or barges with cranes and pile-driving equipment position them. Chains, ropes, connectors, and tensioning hardware are often used to maintain the conventional WEC's orientation and position along the seabed. Additionally, this equipment must be resilient enough to survive marine conditions and thus must resist corrosion, withstand fatigue due to repetitive loading, and adapt to movement without line twisting. Heavy-lift vessels equipped with dynamic positioning systems often play a vital role in ensuring precise installation. Monitoring and tensioning equipment, such as load cells, are also often used for ongoing adjustments and to ensure safe operation and optimized energy capture.

As described above, the dedicated moorings and foundations of conventional WECs can be expensive, both in terms of materials and the specialized equipment required for transport and installation. This complexity often entails heavy-lift vessels, diver support, and other logistics that raise costs significantly. Environmental considerations also arise; disturbing the seabed for anchoring can affect benthic habitats, and mooring lines must be designed with care to minimize entanglement risks to marine life. Further, continuous exposure to saltwater corrosion and heavy wave action limits the reliability of such systems, making them prone to failure over the operational life of the WEC and thus requiring regular inspections and maintenance to minimize the probability of said failures.

Importantly, while at least some conventional WECs rely on ambient air as a convenient medium for harnessing electrical power from wave energy, this approach may not be the most efficient method of harnessing power from wave energy. For example, and not intending to be bound by any specific theory, the fluid power equation for kinetic energy available in a system where the energy is dependent on the velocity of a fluid stream may be represented by Equation (1) below, where P represents power, ρ represents fluid density, U is the fluid velocity, and A is the cross-sectional area of flow:

$${P}_{Fluid} = 0.5 ρ {U}^{3} A \qquad Equation ( 1 )$$

As shown in Equation (1) above, power is directly proportional to the density of the fluid in the system. Thus, as density increases, the power increases. Moreover, when using fluid-based systems for wave energy conversion, only a fraction of the available power can be harnessed. The theoretical maximum efficiency for such systems is governed by the Betz limit, which states that no more than 16/27 (approximately 59%) of the fluids' kinetic energy can be harnessed or converted into mechanical energy. Thus, extracting energy from liquid (e.g., in the form of a water column) may be more efficient than similarly extracting energy from ambient air given the density of water is about 800 times greater than the density of air.

Accordingly, embodiments of systems and methods integrating wave energy extraction systems (WES) along with embodiments of floating WECs are described herein for addressing at least some of the limitations of conventional WECs as outlined above. In an embodiment, a floating wave energy converter comprises a floating body or housing defined by an interior, a fluid channel positioned in the interior and configured to hold a working fluid comprising a volume of water, a turbine coupled to the fluid channel and in direct contact with the working fluid, whereby in response to movement or wave action in a water column, motion is induced in the working fluid to operate the turbine and generate energy. Embodiments of systems and methods integrating wave energy extraction systems along with floating WECs disclosed herein, further comprises a mounting assembly for securely attaching the WEC to an existing marine structure, wherein the mounting assembly is coupled between the housing and the existing marine structure. Marine structures can include, among other examples, port structures, breakwaters, offshore oil and gas platforms, offshore wind platforms, piers, or any other infrastructure system that can be used for WEC integration. However, the WEC can also be designed to operate remotely in shallow, intermediate, or deep waters via mooring line supports. In the latter scenario, the mooring lines can be mounted on the hull of the WEC and the seabed.

In certain embodiments, the mounting assembly comprises one or more support arms pivotably connected to the housing by a pivot joint whereby the WEC is rigidly secured to the existing marine structure while allowing the WEC to rotate about a pivot axis of the pivot joint. Further, embodiments of methods and systems integrating wave energy extraction systems along with floating WECs disclosed herein comprises a mounting assembly connected to the existing marine structure and configured to physically adjust or manipulate the position of the WEC relative to the existing marine structure in response to changing environmental conditions such as in response to incoming inclement weather, and/or in response to changes in the vertical height of the waterline of the water column.

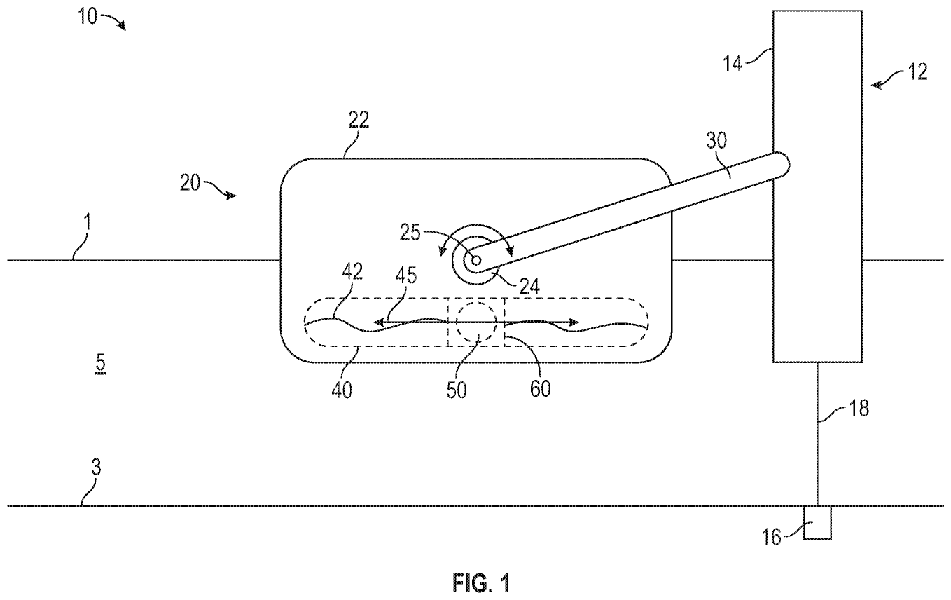

Referring initially to FIG. 1, an embodiment of a wave energy extraction system 10 in a marine environment is shown and which includes marine structure 12 and one or more WECs 20 coupled to and supported by the marine structure 12. In this exemplary embodiment, marine structure 12 includes a surface support structure 14 located at a waterline 1, a foundation 16 anchored to a seabed 3, and a support or mooring line 18 extending through a water column 5 between the foundation 16 and the surface support structure 14 to secure the surface support structure 14 to the seabed 3 using the foundation 16. In other embodiments, surface support structure 14 may be secured to the seabed 3 in ways other than that shown in FIG. 1. For instance, in some embodiments, surface support structure 14 may be rigidly mounted or anchored to the seabed 3. In other embodiments, surface support structure 14 may be positioned atop an earthwork or other solid pile of material extending through the water column 5. Additionally, surface support structure 14 may comprise various kinds of pre-existing marine structure such as, for example, a breakwater, a pier, a jetty, an offshore wind turbine, an offshore oil platform, and an aquaculture farm.

In this exemplary embodiment, WEC 20 generally includes a floating body or housing 22, a mounting assembly 30, an interior fluid channel 40, a turbine 50, and an electrical generator 60. Housing 22 of WEC 20 is mounted or coupled to the surface support structure 14 of marine structure 12 by the mounting assembly 30, which is coupled therebetween. Instead of including a foundation, mooring system, or other dedicated support structure, WEC 20 is instead supported or coupled to the seabed 3 by the marine structure 12. Particularly, in this exemplary embodiment, mounting assembly 30 is pivotably connected to the housing 22 by a pivot joint 24 of the WEC 20 coupled therebetween. Pivot joint 24 permits housing 22 to rotate about a pivot axis 25 (extending out of the page in FIG. 1) extending centrally through the pivot joint 24. In some embodiments, housing 22 is only permitted to rotate about pivot axis 25 relative to surface support structure 14 with housing 22 hard mounted to surface support structure 14 by the mounting assembly 30. For instance, mounting assembly 30 may comprise one or more rigid members or arms extending between the surface support structure 14 and the pivot joint 24.

The fluid channel 40 of WEC 20 is sealed from the surrounding environment (e.g., from water column 5) and may be received within an interior of the housing 22 or is otherwise physically supported by the housing 22 whereby relative movement between the housing 22 and fluid channel 40 is restricted. Additionally, fluid channel 40 is partially filled with a working fluid (or simply “liquid”) 42 that is free to flow or slosh within the fluid channel 40. The working fluid 42 may comprise water similar to the water comprising water column 5. Alternatively, working fluid 42 may comprise liquids other than water and/or mixtures, solutions, etc., thereof. Generally, rotation of housing 22 about pivot axis 25 causes working fluid 42 to flow back-and-forth through the fluid channel 40 as indicated by arrow 45 in FIG. 1. For instance, wave action, sloshing, and/or other motion along waterline 1 may cause housing 22 of WEC 20 to rock back-and-forth about the pivot axis 25 thereof. In this manner, motion in the water comprising water column 5, particularly along the waterline 1, may be transferred therefrom to the working fluid 42 partially filling fluid channel 40 to drive the motion or flow of working fluid 42 therethrough.

The turbine 50 of WEC 20 is at least partially received in the fluid channel 40 and in contact with the working fluid 42 present therein. In this configuration, kinetic energy carried by the flow 45 of working fluid 42 through fluid channel 40 may be transferred to or captured by the turbine 50 via direct contact therebetween (e.g., direct contact between working fluid 42 and one or more turbine or impeller blades of turbine 50). In other words, the flow 45 of working fluid 42 through fluid channel 40 induces motion in the turbine 50. This motion may be rotational motion in one or more rotational directions, and/or linear motion of the turbine 50 in the fluid channel 40. Turbine 50 comprises a self-rectifying turbine where the term “self-rectifying turbine” is defined herein as a turbine that rotates in a single direction regardless of the flow direction. In this manner, self-rectifying turbines may eliminate the need for non-return valves and maximize energy capture based on sloshing of the working fluid.

Electrical generator 60 of WEC 20 is coupled to the turbine 50 and is driven by turbine 50 to transform mechanical energy supplied by the turbine 50 into electrical energy or power (e.g., electricity). Particularly, motion induced in turbine 50 by the flow 45 of working fluid 42 is applied to the electrical generator 60 to generate electrical power. For example, electrical generator 60 may comprise a rotating member or rotor and a fixed member or stator that together form a magnetic circuit including one or more magnets and one or more electrical windings in which an electrical current is induced in response to changes in the magnetic field generated by the one or more magnets. In this manner, motion in the water comprising water column 5 is initially transferred to the working fluid 42 contained in fluid channel 40 as a flow 45 (e.g., a back-and-forth, reciprocating, and/or sloshing flow) of the working fluid 42. In turn, the flow 45 of working fluid 42 induces motion of the turbine 50 which is applied by the turbine 50 to the electrical generator 60 to generate electrical power from the energy of the water comprising water column 5 initially captured by the WEC 20.

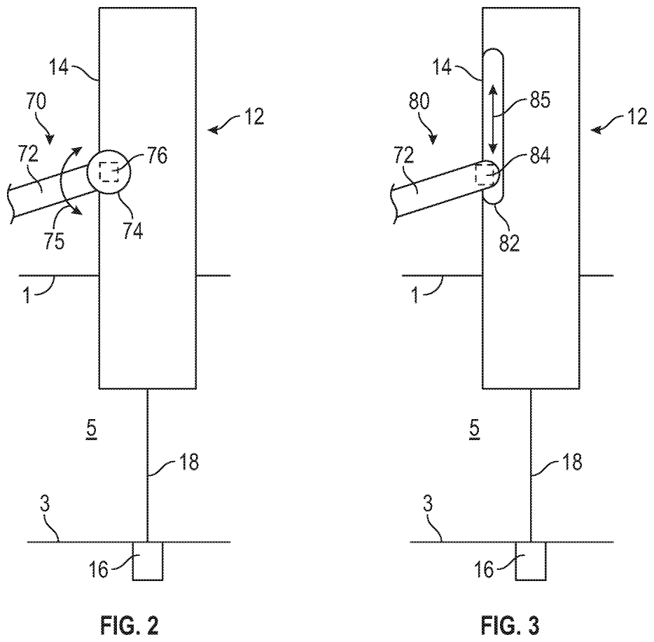

Referring to FIG. 2, another exemplary embodiment of a mounting assembly 70 of a wave energy extraction system (e.g., wave energy extraction system 10 of FIG. 1) is shown. In this exemplary embodiment, mounting assembly 70 comprises a control device 76, a pivot joint 74 that allow for rotating and adjusting (e.g., lifting and lowering) a WEC (e.g., WEC 20 of FIG. 1), and one or more rigid members or arms 72 coupled to the pivot joint 74. In some embodiments, the WEC is mounted or coupled to the surface support structure 14 of marine structure 12 by the mounting assembly 70, which is coupled therebetween. In this instance, the arms 72 of the mounting assembly 70 may be coupled to and extend from the surface support structure 14 to the WEC.

The mounting assembly 70 is pivotably connected to the surface support structure 14 by the pivot joint 74 coupled therebetween. Pivot joint 74 permits mounting assembly 70 to rotate about a pivot axis 75 of the pivot joint 74. In some embodiments, mounting assembly 70 is only permitted to rotate about pivot axis 75 relative to surface support structure 14. The control device 76 of mounting assembly 70 is coupled to the pivot joint 74 and may generally include a power supply unit, computer-implemented controller (e.g., comprising one or more processors and one or more memory devices encoded with instructions executable by the one or more processors), sensors, and one or more actuators such as rotary actuators (e.g., electromechanical actuators, hydraulic actuators, pneumatic actuators).

In some embodiments, the control device 76 may be configured to supply the power necessary to rotate and control the arms 72. For instance, the control device 76 may physically adjust or manipulate the position of the WEC (e.g., WEC 20 of FIG. 1) relative to the surface support structure 14 in response to receiving one or signals from the controller disposed therein. In this manner, when a control signal is received (e.g., from an operator, sensor data, or preset conditions) by the controller through a control panel or other interface of a wave extraction system (e.g., wave energy extraction system 10 of FIG. 1), the controller may issue a command to rotate the arms 72 about the pivot joint 74, permitting the WEC to be lifted or lowered and/or disengaged from the surface support structure 14 or to adjust the position of the WEC in response to changing environmental conditions such as in response to incoming inclement weather, and/or in response to changes in the vertical height of the waterline of the water column.

Referring to FIG. 3, yet another exemplary embodiment of a mounting assembly 80 of a wave energy extraction system (e.g., wave energy extraction system 10 of FIG. 1) is shown. In this exemplary embodiment, mounting assembly 80 comprises a control device 84, a sliding joint 82 that allow for lifting and lowering a WEC (e.g., WEC 20 of FIG. 1), and one or more rigid members or arms 72 coupled to the sliding joint 82. In some embodiments, the WEC is mounted or coupled to the surface support structure 14 of marine structure 12 by the mounting assembly 80, which is coupled therebetween. In this instance, the arms 72 of the mounting assembly 80 may be coupled to and extend from the surface support structure 14 to the WEC.

The mounting assembly 80 is slidably connected to the surface support structure 14 by the sliding joint 82 coupled therebetween. Sliding joint 82 permits mounting assembly 80 to move along an axis 85 of the sliding joint 82. In some embodiments, mounting assembly 80 is only permitted to move or slid along the axis 85 relative to surface support structure 14. The control device 84 of mounting assembly 80 is coupled to the sliding joint 82 and may generally include a power supply unit, computer-implemented controller (e.g., comprising one or more processors and one or more memory devices encoded with instructions executable by the one or more processors), sensors, and one or more actuators such as linear actuators (e.g., electromechanical actuators, hydraulic actuators, pneumatic actuators).

In some embodiments, the control device 84 may be configured to supply the power necessary to move and control the arms 72. For instance, the control device 84 may physically adjust or manipulate the position of the WEC relative to the surface support structure 14 in response to receiving one or signals from the controller. In this manner, when a control signal is received (e.g., from an operator, sensor data, or preset conditions) by the controller through a control panel or other interface of a wave energy extraction system (e.g., wave energy extraction system 10 of FIG. 1), the controller may issue a command to move the arms 72 about the sliding joint 82, permitting the WEC (e.g., WEC 20 of FIG. 1) to be lifted or lowered and/or disengaged from the surface support structure 14 or to adjust the position of the WEC in response to changing environmental conditions such as in response to incoming inclement weather, e.g., a storm, hurricane, and the like, and/or in response to changes in the vertical height of the waterline of the water column. In some embodiments, control device 84 of mounting assembly 70 may include manual, hydraulic, pneumatic, or electric powered systems. Alternatively, the mounting assembly 80 may be manually operated in other embodiments, whereby the mounting assembly 80 is operated by manually lifting and lowering the WEC using, for example, a lever coupled to the mounting assembly 80.

In other embodiments, the wave energy extraction system (e.g., wave energy extraction system 10 of FIG. 1) may not include a moveable mounting assembly and instead may comprise a fixed mounting assembly to which the WEC (e.g., WEC 20 of FIG. 1) is releasably coupled. In such an embodiment, the WEC may be manually decoupled and retrieved from the marine structure 12 as desired by an operator of the wave energy extraction system.

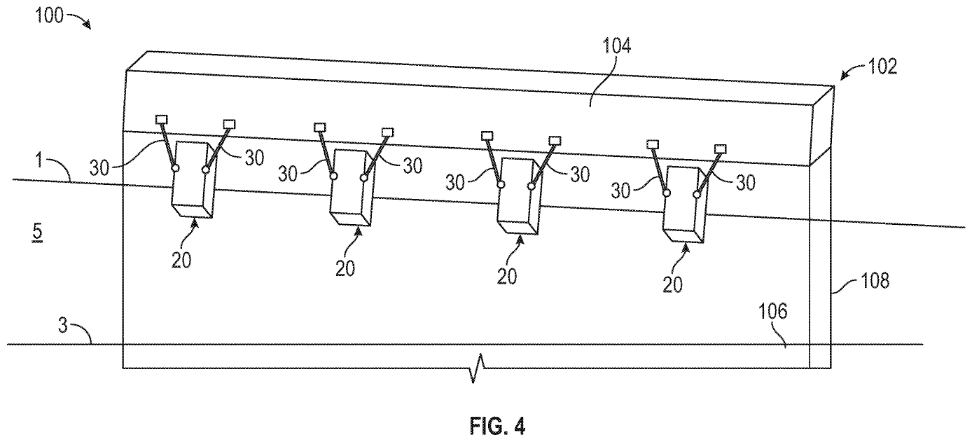

Referring to FIG. 4, another embodiment of a wave energy extraction system 100 in a marine environment is shown. Wave energy extraction system 100 may include features in common with wave energy extraction system 10 shown in FIG. 1, and shared features are labeled similarly. The wave energy extraction system 100 includes a modular design comprising a plurality of separate, self-contained WECs supported by a preexisting marine structure in the form of a breakwater 102. Particularly, wave energy extraction system 100 comprises a plurality of the WECs 20 shown in FIG. 1. Alternatively, wave energy extraction system 100 may comprise a plurality of WECs that vary in configuration from WECs 20 in other embodiments. The WECs 20 may be connected, for example, via subsea cables that carry or transport the power generated by each unit to either a central hub or directly to a power grid. In some embodiments, multiple WECs 20 may be connected through a single cable or grouped in clusters to optimize power generation and distribution. Further, individual WECs 20 of the wave energy extraction system 100 may be arranged in a pattern that vary from that shown in FIG. 4. For example, instead of a linear or parallel pattern, the arrangement of WECs 20 may be non-linear or staggered, comprise a grid pattern, radial pattern, or any other configuration to optimize wave energy conversion.

Particularly, in this exemplary embodiment, breakwater 102 includes an existing breakwater comprising an outer layer 104 located at waterline 1, a foundation layer 106 anchored to seabed 3, and a support layer 108 extending through water column 5 between the foundation layer 106 and the outer layer 104 to connect and secure the outer layer 104 to seabed 3. Breakwater 102 may be designed to mitigate or prevent the impact of waves or water movement in a body of water (e.g., water column 5 of FIG. 1), and may be configured in ways other than that shown in FIG. 4. For instance, in some embodiments, outer layer 104 may be partially or fully submerged in water column 5 depending on the specific application (e.g., offshore or coastal placement), and wave characteristics. Additionally, breakwater 102 may be tailored in size, shape, and material composition to suit specific environmental conditions. For example, the outer layer 104, support layer 108, and the foundation layer 106 may be constructed in various shapes (e.g., vertical, slope, slant, mound, etc.) and from one or more combinations of materials such as rocks, concrete, steel caisson, or composite materials, in varying sizes, and arrangements configured to secure and protect marine equipment from the damaging effects of waves.

As with wave energy extraction system 10 shown in FIG. 1, the WECs 20 of wave energy extraction system 100 are not individually anchored to the seabed 3 and instead conveniently rely on preexisting infrastructure for their support in the form of breakwater 102, thereby minimizing the amount of time and expense for installing WECs 20 by eliminating the need to build additional infrastructure for separately supporting the WECs 20 along the seabed 3. Particularly, instead of including a dedicated support structure, the plurality of WECs 20 of the wave energy extraction system 100 are instead supported or coupled to the existing breakwater 102 by mounting assemblies 30, which is coupled therebetween, thereby reducing the installation and operating cost of the wave energy extraction system 100 significantly. In this exemplary embodiment, each mounting assembly 30 is rigidly attached to the outer layer 104 of breakwater 102 such that relative movement between the mounting assembly 30 and the outer layer 104 is restricted. Additionally, each mounting assembly 30 is pivotably coupled to a corresponding WEC 20 to permit relative rotation therebetween to facilitate the operation of WECs 20 in generating electrical power from the wave energy imparted to the WECs 20.

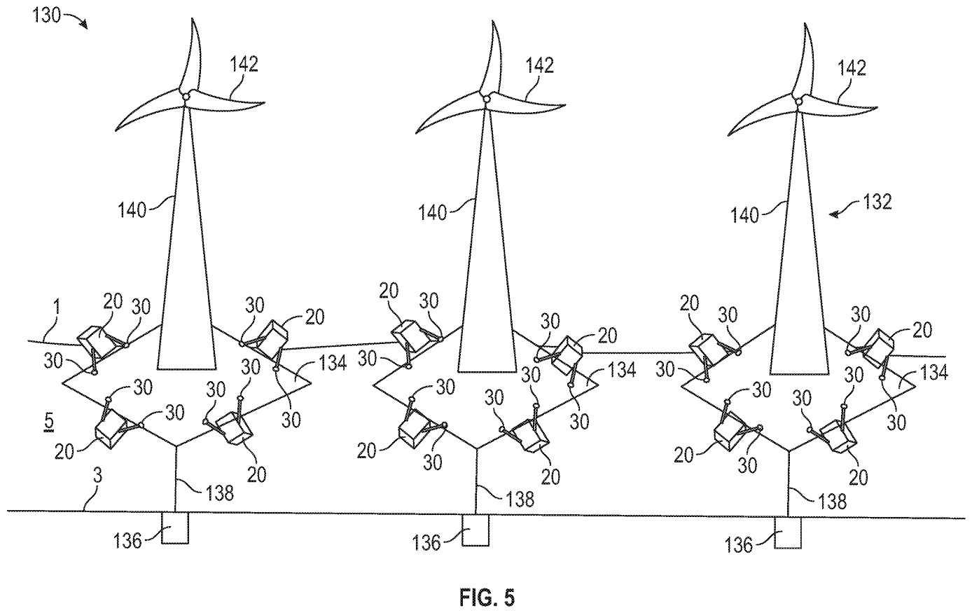

Referring to FIG. 5, another embodiment of a wave energy extraction system 130 in a marine environment is shown. Wave energy extraction system 130 may include features in common with wave energy extraction system 10/100 shown in FIGS. 1 and 4, and shared features are labeled similarly. The wave energy extraction system 130 includes a modular design comprising a plurality of separate, self-contained WECs coupled to and supported by a preexisting marine structure in the form of a plurality of wind turbines 132. Particularly, wave energy extraction system 130 comprises a plurality of the WECs 20 shown in FIG. 1. Alternatively, wave energy extraction system 130 may comprise a plurality of WECs that vary in configuration from WECs 20 in other embodiments. The WECs 20 may be connected, for example, via subsea cables that carry or transport the power generated by each unit to either a central hub or directly to a power grid. In some embodiments, multiple WECs 20 may be connected to a single cable or grouped in clusters to optimize power generation and distribution. Further, the number and arrangement of the individual WECs 20 of the wave energy extraction system 130 may vary from that shown in FIG. 5, depending on the specific application.

Particularly, in this exemplary embodiment, each wind turbine 132 includes a base 134 located at a waterline 1, a tower 140 located atop the base 134 and having a plurality of blades 142, one or more foundations 136 anchored to a seabed 3, and one or more support anchor or mooring line 138 extending through the water column 5 between the foundation 136 and the base 134 to secure the base 134 to the seabed 3 using the foundation 136. In other embodiments, base 134 may be secured to the seabed 3 in ways other than that shown in FIG. 3. For instance, in some embodiments, base 134 may be rigidly mounted or anchored to the seabed 3. Alternatively, base 134 may be positioned atop an earthwork or other solid pile of material extending through the water column 5, or may extend directly from the seabed 3 to the waterline 1. Additionally, base 134 may comprise various kinds of pre-existing structures configured to secure the wind turbine 132 to the seabed 3.

In this exemplary embodiment, WECs 20 are pivotably coupled to the bases 134 of wind turbines 132 via mounting assemblies 30. Particularly, instead of including a dedicated support structure, the WECs 20 of the wave energy extraction system 130 are instead supported or coupled to the existing base 134 of the wind turbine 132. In this manner, the energy from both the existing wind turbine 132 and the WEC 20 may be transmitted to a central station or grid using shared infrastructure. Thus, the use of or sharing of existing infrastructure (i.e., wind turbine 132) may provide reduced installation, maintenance, monitoring, and operational costs.

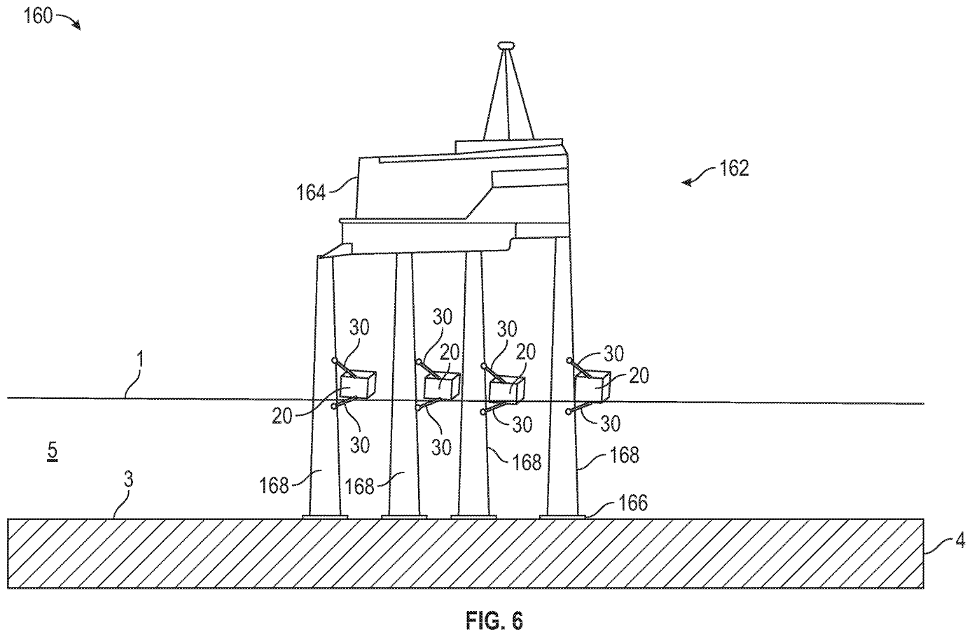

Referring to FIG. 6, another embodiment of a wave energy extraction system 160 in a marine environment is shown. Wave energy extraction system 160 may include features in common with wave energy extraction system 10, 100, and 130 shown in FIGS. 1, 4, and 5, and shared features are labeled similarly. The wave energy extraction system 160 includes a modular design comprising a plurality of separate, self-contained WECs coupled to and supported by a preexisting marine structure in the form of a hydrocarbon platform 162. Particularly, wave energy extraction system 160 comprises a plurality of the WECs 20 shown in FIG. 1. Alternatively, wave energy extraction system 160 may comprise a plurality of WECs that vary in configuration from WECs 20 in other embodiments. The WECs 20 may be connected, for example, via subsea cables that carry or transport the power generated by each unit to either a central hub or directly to a power grid. In some embodiments, multiple WECs 20 may be connected to a single cable or grouped in clusters to optimize power generation and distribution. Further, the number and arrangement of the individual WECs 20 of the wave energy extraction system 160 may vary from that shown in FIG. 6, depending on the specific application.

Particularly, in this exemplary embodiment, hydrocarbon platform 162 is generally configured to extract hydrocarbons from one or more wells which extends into a subterranean formation 4 below the seabed 3 of the water column 5. The hydrocarbon platform 162 generally comprises a storage vessel 164 located above the waterline 1 (for example, a floating production storage and offloading system (FPSO)) for processing and storing the extracted hydrocarbons, one or more foundation 166 anchored to the seabed 3, one or more support structure 168 extending through the water column 5 between the foundation 166 and the storage vessel 164 to secure the storage vessel 164 to the seabed 3, and a plurality of subsea fluid conduits or pipelines (not shown) that connect a plurality of productions wells to the storage vessel 164. The hydrocarbon platform 162 may also include marine risers that convey the extracted hydrocarbons to storage vessel 164 for processing and storage, as well as fittings, valves, pumps, booster stations, flowmeters and other equipment that facilitate hydrocarbon production. It may be understood that the configuration of hydrocarbon platform 162 may vary substantially in other embodiments from that shown in FIG. 6. More particularly, the WECs 20 of the wave energy extraction system 160 are coupled to and supported by the hydrocarbon platform 162. Instead of including a dedicated support structure, WECs 20 are instead supported or coupled to the existing support structure 168 of the hydrocarbon platform 162, thereby reducing installation costs.

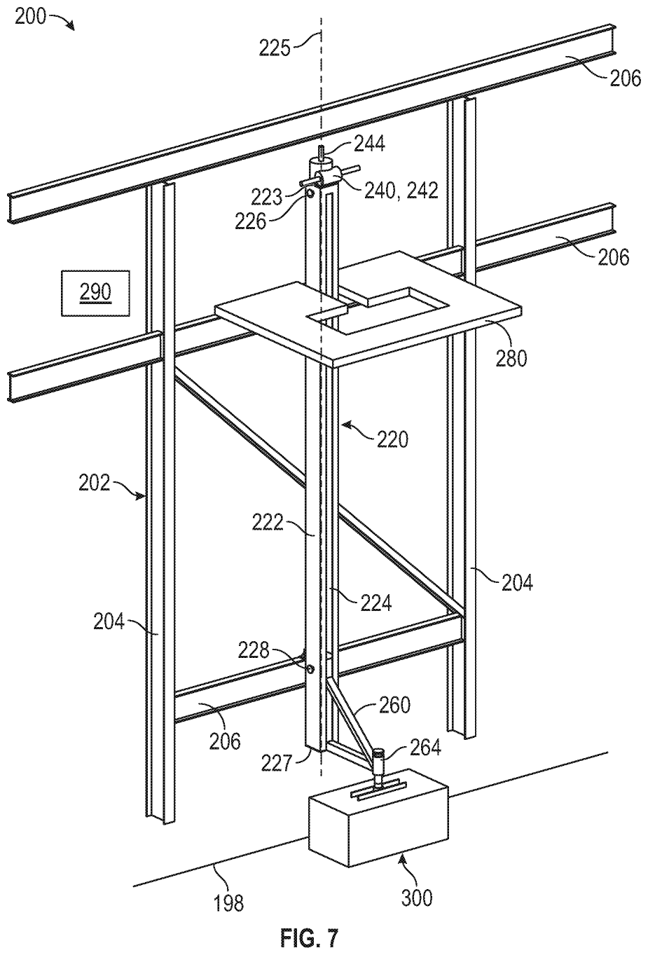

Referring to FIGS. 7-9, another embodiment of a wave energy extraction system 200 in a marine environment is shown. Wave energy extraction system 100 may include features in common with wave energy extraction system 10, 100, and 130 shown in FIGS. 1, 4, and 5, and shared features are labeled similarly. In this exemplary embodiment, wave energy extraction system 200 generally includes a marine structure 202 extending vertically from a waterline 198, a mounting assembly 220, and a WEC 300 movably couple to the marine structure 202 by the mounting assembly 220. Although only a single mounting assembly 220 and WEC 300 are shown in FIGS. 7-9, in certain embodiments, a plurality of mounting assemblies 220 and WECs 300 may be coupled to the marine structure 202.

In this exemplary embodiment, marine structure 202, includes a plurality of vertically extending members or beams 204 and a plurality of horizontally extending members or beams 206 connected to the vertical beams 204. Marine structure 202 may include additional features not shown in FIGS. 7-9. Additionally, marine structure 202 may form part of various types of offshore infrastructure including wind turbines and other systems.

In this exemplary embodiment, the mounting assembly 220 generally includes a vertically extending rail 222, an elevator 230 transportable vertically along the vertical rail 222, a linear actuator 240 coupled between the vertical rail 222 and the elevator 230, a mount 260 pivotably coupling the WEC 300 to the elevator 230, a vertically elevated service platform 280, and a system controller 290. Vertical rail 222 is coupled to the marine structure 202 such that relative movement is restricted therebetween. For instance, vertical rail 222 may be welded to different horizontal beams 206 of the marine structure 202 via hangers coupled along the vertical rail 222. Additionally, vertical rail 222 extends longitudinally along a longitudinal or central axis 225 between a first or vertically upper end 223 and an opposing second or vertically lower end 227. Vertical rail 222 includes a central passage extending between ends 223 and 227 and which receives the elevator 230. Further, a frontal opening 224 is formed in the vertical rail 222 through which the mount 260 extends. In some embodiments, the lower end 227 of vertical rail 222 is enclosed by an endcap and the like to prevent the intrusion of water into the central passage thereof. In some embodiments, vertical rail 222 comprises a slotted box girder and the like; however, the configuration of vertical rail 222 may vary in other embodiments.

The elevator 230 of mounting assembly 220 is slidably received in the central passage of vertical rail 222 and is transportable therethrough in opposing linear directions in response to the operation of linear actuator 240. As shown particularly in FIG. 9, elevator 230 generally includes an elongate elevator body 232 having a central passage 234 extending therethrough between opposing vertically upper and lower ends of the elevator body 232. Additionally, in this exemplary embodiment, a splash guard 236 partially covers the lower end of the elevator body 232 to protect the elevator 230 from water located at the waterline 198. The elevator body 232 is keyed to the vertical rail 222 whereby relative rotation about longitudinal axis 225 between elevator 230 and the vertical rail 222 is restricted. For instance, in this exemplary embodiment, elevator body 232 has a square or rectangular cross-section matching a square or rectangular cross-section of the central passage of vertical rail 222 whereby interference between elevator body 232 and vertical rail 222 restricts relative rotation therebetween about longitudinal axis 225.

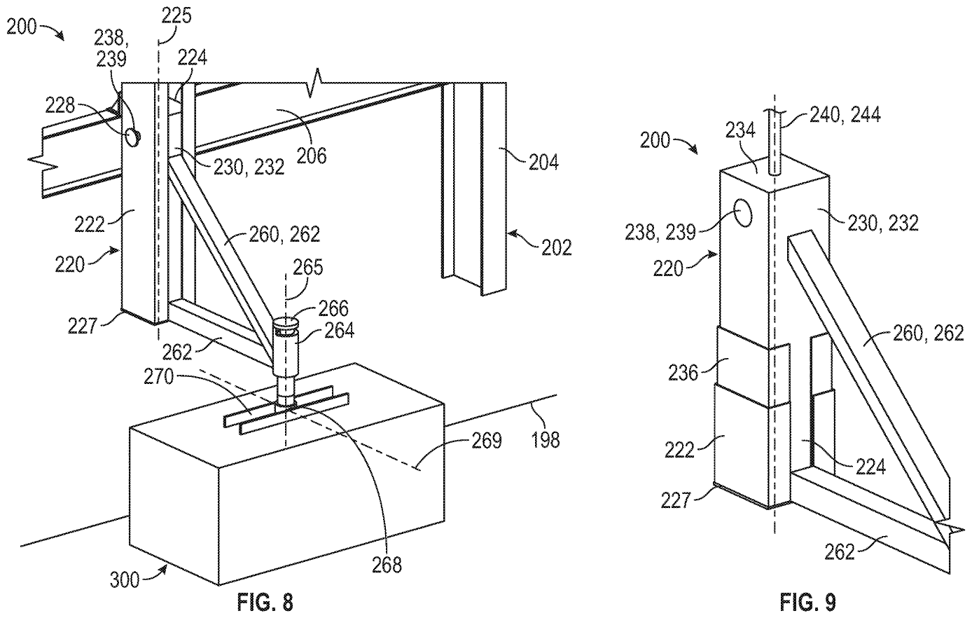

As shown particularly in FIG. 8, elevator 230 additionally includes a locking pin 238 coupled to the elevator body 232. Locking pin 238 is receivable in a pair of receptacles or openings 226 and 228 formed in the vertical rail 222 to lock the vertical position of elevator 230 along the vertical rail 222. Particularly, locking pin 238 is actuatable by a linear actuator 239 coupled to the elevator body 232 between a first or retracted position that unlocks the elevator 230 from the vertical rail 222, and a second or extended position that is received in one of the receptacles 226 and 228 to lock the elevator 230 to the vertical rail 222 thereby restricting relative longitudinal movement along longitudinal axis 225 between elevator 230 and vertical rail 222. In some embodiments, linear actuator 239 comprises a hydraulic actuator or piston while in other embodiments linear actuator 239 may comprise a pneumatic actuator or piston, an electromechanical actuator, and the like. In other embodiments, however, mounting assembly 220 may not include locking pin 238 and its corresponding linear actuator 239.

The linear actuator 240 of mounting assembly 220 is operable to displace elevator 230 and WEC 300 along longitudinal axis 225 in either longitudinal direction. In this exemplary embodiment, linear actuator 240 includes a prime mover or motor 242 (e.g., a rotary actuator, an electric motor) and an elongate, externally threaded rod or screw 244 that extends longitudinally through the central passage of vertical rail 222. Motor 242 is coupled to the vertical rail 222 and is configured to rotate the threaded rod 244 about the longitudinal axis 225 in either rotational direction. Additionally, the threaded rod 244 extends or is threaded into and through the central passage 234 of the elevator body 232. Central passage 234 is internally threaded such that the threaded rod 244 threadably engages the threaded inner surface of central passage 234. In this configuration, rotation of threaded rod 244 about longitudinal axis 225 results in linear displacement of the elevator 230 in either longitudinal direction along longitudinal axis 225 depending on the angular direction of the rotation of threaded rod 244. However, in other embodiments, the configuration of linear actuator 240 may vary. For instance, in other embodiments, linear actuator 240 may comprise a hydraulic or pneumatic actuator with elevator 230 comprising, for example, a piston.

The mount 260 of mounting assembly 220 couples the WEC 300 to the elevator 230 whereby longitudinal motion of the elevator 230 along longitudinal axis 225 is transferred in concert to the WEC 300. As shown particularly in FIG. 8, in this exemplary embodiment, mount 260 comprises one or more struts 262, a first pivot joint or connector 264, an elongate pivot pin 266 coupled to the first pivot connector 264, a second pivot joint or connector 268, and a connector member 270 for connecting the mount 260 to the WEC 300. Struts 262 may each be elongate in shape extending between first ends coupled to the elevator body 232 of elevator 230 and opposing second ends coupled to the first pivot connector 264.

The first pivot connector 264 defines a first or vertical pivot axis 265 while the second pivot connector 268 defines a second or horizontal pivot axis 269 that may intersect the vertical pivot axis 265 in some embodiments. The vertical pivot axis 265 extends parallel the longitudinal axis 225 of vertical rail 222 while the horizontal pivot axis 269 extends at a non-zero angle relative to the first pivot axis 265 and longitudinal axis 225. In some embodiments, the horizontal pivot axis 269 extends orthogonally relative to the vertical pivot axis 265.

In this exemplary embodiment, a first end of the pivot pin 266 may pivotably couple to the first pivot connector 264 while a longitudinally opposed second end of the pivot pin 266 couples to the second pivot connector 268. Additionally, the WEC 300 pivotably couples to the second pivot connector 268 via the connector member 270 coupled therebetween. In this configuration, the WEC 300 is permitted to pivot concurrently about both the vertical pivot axis 265 and the horizontal pivot axis 269. In some embodiments, the pivoting of WEC 300 about first pivot axis 265 and/or about second pivot axis 269 may be limited by stops or other devices such that WEC 300 is only permitted to pivot about a predefined arcuate sweep about pivot axes 265 and 269. For instance, in some embodiments, WEC 300 may be pivotable approximately 180 degrees about first pivot axis 265 and approximately 120 degrees about horizontal pivot axis 269. However, in other embodiments, the arcuate sweep of WEC 300 about pivot axes 265 and 269 may vary.

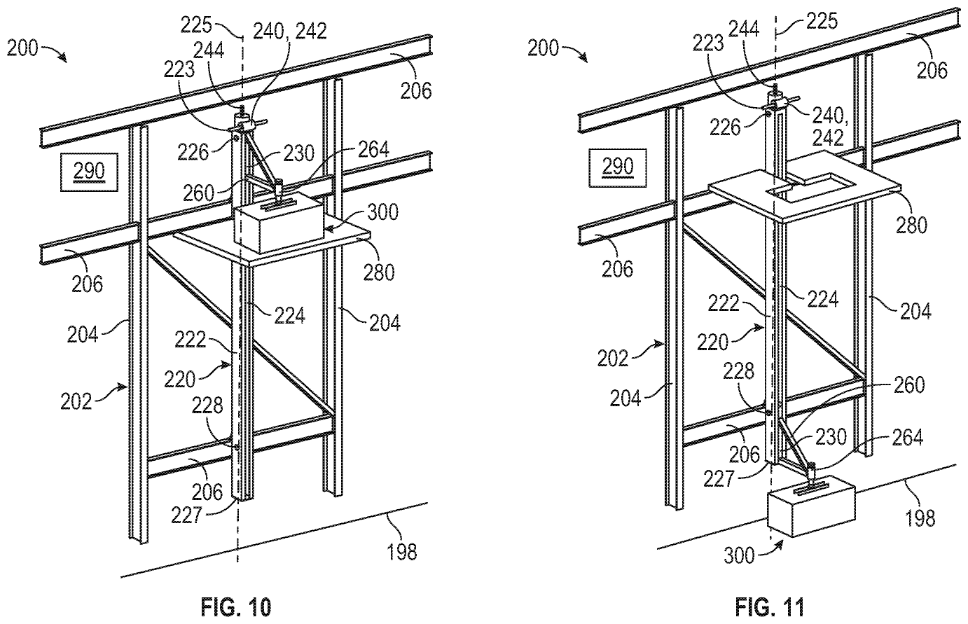

Referring to FIGS. 10 and 11, the operation of linear actuator 240 and/or 368 may be controlled by system controller 290 of mounting assembly 220. For instance, the motor 242 of linear actuator 240 and linear actuator 239 may be electrically connected or otherwise in signal communication with system controller 290 to permit system controller 290 to control the operation thereof. Particularly, system controller 290 may control linear actuator 239 to selectably shift locking pins 238 between their retracted and extended positions to unlock and lock, respectively, elevator 230 to the vertical rail 222. Additionally, with locking pins 238 in their retracted positions, system controller 290 may operate linear actuator 240 to transport WEC 300 between a first or retracted position shown in FIG. 10 located vertically above the waterline 198, and a second or deployed position shown in FIG. 11 located at the waterline 198.

In the retracted position, elevator 230 is positioned at the upper end 223 of vertical rail 222 and the WEC 300 is positioned at the service platform 280 by personnel of wave energy extraction system 200. For instance, in the retracted position, WEC 300 may be inspected, maintained, replaced, or otherwise surfaced at a convenient location proximal surface platform 280. Conversely, in the deployed position, elevator 230 is positioned at the lower end 227 of vertical rail 222 and WEC 300 is located at the waterline 198 whereby WEC 300 may passively generate electrical energy or power. In some embodiments, system controller 290 comprises one or more input/output (I/O) devices to permit users to control the operation of linear actuator 240 and/or locking pins 238 either at the location of mounting assembly 220 or at locations remote therefrom.

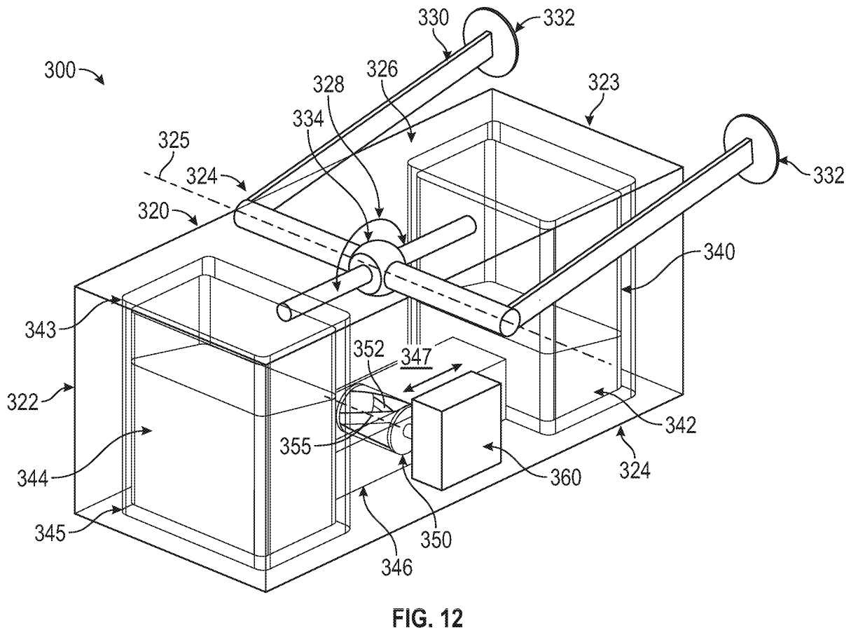

Referring to FIG. 12, another exemplary embodiment of a WEC 300 is shown. The WEC 300 may be utilized in any of the aforementioned wave energy extraction systems (e.g., wave energy extraction systems 10, 100, 130, 160, and 200) described herein as well as wave energy extraction systems that vary in configuration from those described explicitly herein. The WEC 300 generally includes an outer shell or housing 320 (shown as transparent in FIG. 7 to illustrate internal details thereof), a turbine 350 (e.g., a self-rectifying turbine) at least partially received in the housing 320, and an electrical generator 360 coupled to the turbine 350. Additionally, FIG. 12 illustrates a mounting assembly 330 for mounting the WEC 300 to a marine structure. In other embodiments, WEC may be coupled to marine structures using other mechanisms such as the mounting assembly 220 shown in FIGS. 7-11.

In this exemplary embodiment, the housing 320 includes a generally rectangular or box-like shape extending from a front end 322 to an opposed back end 323 and comprising a bottom end (not visible in FIG. 7), a pair of opposing lateral sides 324, and a top end 326 opposing the bottom end thereof. Alternatively, the housing 320 may comprise other shapes and configurations that vary from that shown in FIG. 1. For example, housing 320 may include an oval shape, a sphere, rounded sides or any other shape/structure that allows the WEC 300 to be buoyant in a water column. The housing 320 may be constructed from various materials including stainless steel, aluminum, composites (e.g., fiberglass or carbon fiber), concrete, plastic, wood, light iron, or other corrosion-resistant materials. The housing 320 may also be constructed from ultra-high-performance concrete (UHPC) due to its enhanced durability against severe marine environments. In some embodiments, the size, shape and choice of construction material for the housing 320 may be selected such that the natural frequency of the floating housing 320 of WEC 300 is aligned with the dominant wave frequency of the water column in order to achieve resonance and thereby maximize energy capture.

Additionally, the housing 320 of the WEC 300 is defined by an interior 328 comprising a generally U-shaped fluid channel 340 that is sealed from the surrounding environment (e.g., from the water column). In this exemplary embodiment, the fluid channel 340 includes a pair of vertical channels 344 each extending between a vertically upper end 343 and a longitudinally opposed vertically lower end 345. Additionally, fluid channel 340 includes a horizontal channel 346 that fluidically connects the pair of vertical channels 344 at the lower ends 345 thereof. The U-shaped tube provides a flow path for a working fluid 342 (e.g., water) contained therein while allowing changes in the direction of fluid flow in the fluid channel 340, such as in a sloshing motion of liquid contained therein, in response to rotation of housing 320. Particularly, the working fluid 342 fills the horizontal channel 346 and partially fills each of the vertical channels 344 with the amount of working fluid 342 contained in each vertical channel 344 varying depending on the angular orientation of housing 320, as will be discussed further herein. Fluid channel 340 may alternatively comprise configurations that vary from that shown in FIG. 7. For example, fluid channel 340 may comprise three or more vertical channels 344 each connected by a horizontal channel 346 in other embodiments, or comprise other shapes that may facilitate fluid flow and changes in fluid direction across the fluid channel 340. The fluid channel 340 may be constructed from various materials, including metals, plastics, glass and so on, depending on the environmental conditions and/or to align the natural frequency of the WEC 300 with the dominant wave frequency of the water column.

In this exemplary embodiment, mounting assembly 330 comprises a pair of support arms 332 and a pivot joint 334. The pair of support arms 332 are pivotably connected to the housing 320 by the pivot joint 334. Although mounting assembly 330 comprises a pair of support arms 332, in other embodiments, mounting assembly 330 may comprise a single support arm 332 or more than two support arms 332. The pair of support arms 332 and the pivot joint 334 of the mounting assembly 330 allow housing 320 of the WEC 300 to be mounted or rigidly coupled to a marine structure (e.g., surface support structure 14 of FIG. 1) while permitting the WEC 300 to rotate about a pivot axis 325 extending centrally through and defined by the pivot joint 334. In some embodiments, housing 320 is only permitted to rotate about axis 325 relative to the marine structure with housing 320 hard mounted to the marine structure by the support arms 332 of mounting assembly 330.

In some embodiments, support arms 332 are stationary relative to the marine structure to which they are attached. In other embodiments, support arms 332 are selectably moveable relative to the marine structure. Particularly, mounting assembly 330 may provide a mechanism for lifting and/or lowering the WEC 300 during installation and removal as previously described. The mechanism may also lift and/or lower the mounting assembly 330 in response to changing environmental conditions such as in response to incoming inclement weather and/or in response to changes in the vertical height of the waterline of the water column. Additionally, the WEC 300 is securely attached to an existing marine structure (e.g., breakwater 102 of FIG. 4, wind turbine 132 of FIG. 5, or hydrocarbon platform 162 of FIG. 6) through the mounting assembly 330 without requiring any changes to the existing marine structure. This is of particular importance for offshore wind structures and offshore oil platforms where deck space is limited and frequently reserved for other operations. Additionally, new permitting may not be required as the marine structure already exists.

As described above, the fluid channel 340 of WEC 300 is partially filled with a working fluid 342 that is free to flow or slosh within the fluid channel 340. The working fluid 342 may comprise water similar to the water comprising the water column. Alternatively, working fluid 342 may comprise liquids other than water and/or mixtures, solutions, etc., thereof. As previously described, rotation of housing 320 about pivot axis 325 causes working fluid 342 to flow back-and-forth through the fluid channel 340 and particularly, back-and-forth through the horizontal channel 346 thereof as indicated by arrow 347 in FIG. 7. For instance, wave action, sloshing, and/or other motion along waterline 1 may cause housing 320 of WEC 300 to rock back-and-forth about the pivot axis 325 thereof. In this manner, motion in the water comprising the water column, particularly along the waterline 1, may be transferred therefrom to the working fluid 342 partially filling fluid channel 340 to drive the motion or flow of working fluid 342 therethrough. In some embodiments, the volume of the working fluid 342 in the fluid channel 340 may be configured to align the natural frequency of the WEC 300 with the dominant wave frequency of the water column.

The turbine 350 of the WEC 300 is at least partially received in the fluid channel 340 and in direct contact with the working fluid 342 present therein. In this exemplary embodiment, the turbine 350 comprises one or more impellers or blades 352 which translate the generally linear flow 347 of working fluid 342 through horizontal channel 346 into rotation of the turbine 350 about a turbine axis 355. Although turbine axis 355 is shown extending parallel rotation axis 325 and orthogonal the direction of horizontal channel 346, the orientation of turbine axis 355 may vary in other embodiments. For instance, in some embodiments, the turbine axis 355 may extend parallel the direction of horizontal channel 346 and orthogonal the rotation axis 325. In some embodiments, turbine 350 comprises a Gorlov turbine including a plurality of helical turbine blades. In other embodiments, turbine 350 comprises a Savonious turbine or a Darrieus turbine. In still other embodiments, turbine 350 may comprise other forms of turbines including straight-bladed turbines. Thus, a number of different turbine designs may be employed.

In the manner described above, kinetic energy carried by the sloshing motion or movement of the working fluid 342 through the fluid channel 340 may be transferred to or captured by the turbine 350 via direct contact between the working fluid 342 and the one or more blades of the turbine 350. Particularly, the flow or movement of the working fluid 342 through the fluid channel 340 induces motion in the turbine 350 (e.g., rotational motion in one or more rotational directions, and/or linear motion of the blades of the turbine 350), which is in direct contact with the working fluid in the fluid channel 340.

Electrical generator 360 of the WEC 300 is coupled to the turbine 350 and is driven by turbine 350 to transform mechanical energy supplied by the turbine 350 into electrical energy or power (e.g., electricity). As previously described, motion induced in turbine 350 by the working fluid 342 is applied to the electrical generator 360 to generate electrical power. In this manner, motion in the water comprising the water column is initially transferred to the working fluid 342 contained in the fluid channel 340 (e.g., a back-and-forth, reciprocating, and/or sloshing flow) of the working fluid 342 which in turn induces motion of the turbine 350 and applied to the electrical generator 360 to generate electrical power from the energy of the water comprising the water column initially captured by the WEC 300.

Referring to FIG. 13, an exemplary embodiment of a turbine 400 (e.g., a self-rectifying turbine) of the WEC 300 of FIG. 12 is shown. In this exemplary embodiment, turbine 400 comprises a generally cylindrical shape having a longitudinal or central axis 405 and defined by a first support plate 402 forming a first longitudinal end of the turbine 400, a second support plate 404 forming a second longitudinal end of the turbine 400, and one or more blades 406 extending generally helically between the first support plate 402 and the second support plate 404. In this exemplary embodiment, turbine 400 comprises a plurality of helical blades 406 positioned perpendicular to the fluid flow and configured to translate the generally linear flow of a working fluid (e.g., water) into mechanical rotation of the turbine 400 about the turbine axis 405. In some embodiments, turbine 400 additionally includes a plurality of bearings used to support the turbine 400, and may be coupled to a generator configured to convert the mechanical energy induced in the turbine blades 406 into electrical energy. As previously described, turbine 400 is positioned in the horizontal channel of the WEC and in direct contact with the working fluid to capture the energy induced in the working fluid as will be disclosed further herein. As the working fluid sloshes around the turbine 400 in response to water movement or wave action acting on the WEC (e.g., WEC 300), the sloshing movement causes the helical blades 406 to rotate around the central shaft, converting the kinetic energy of the waves or water column into rotational mechanical energy. In other embodiments, the turbine of WEC 300 of FIG. 12 may vary in configuration from the turbine 400 of FIG. 13.

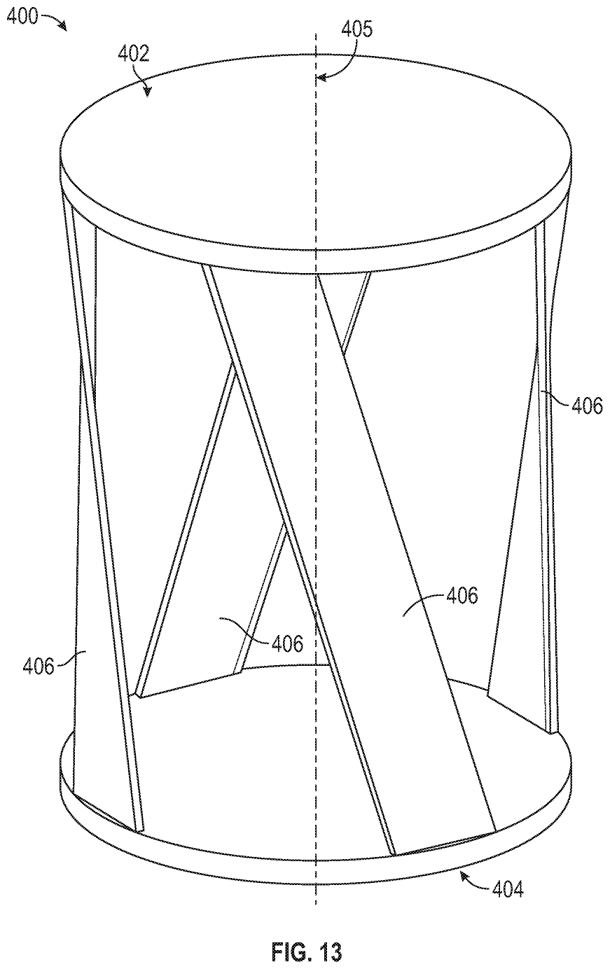

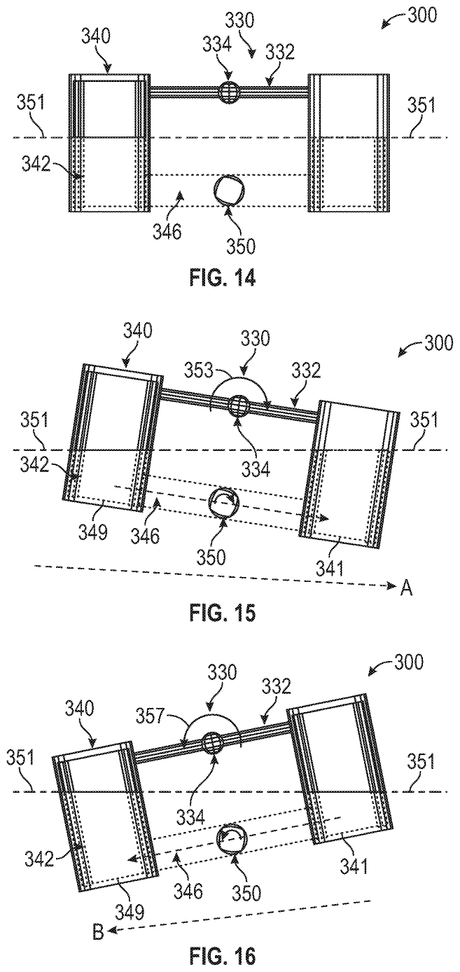

Referring to FIGS. 14-16, to illustrate exemplary operational features of WEC 300, an exemplary implementation of the WEC 300 of FIG. 12 is shown. Particularly, FIG. 14 illustrates the WEC 300 disposed in an initial or neutral position floating on the waterline of a water column (e.g., water column 5 of FIG. 1) with no water movement or wave action being applied by the water column to the WEC 300. In this exemplary embodiment, the fluid channel 340 of WEC 300 is partially filled with working fluid 342 (e.g., water) up to a fixed line or level 351 that is equal or balanced in each of the pair of vertical channels 344 of the fluid channel 340 with WEC 300 in the neutral position. The fluid volume or level 351 of the working fluid 342 in the fluid channel 340 may be configured based at least in part on the actual or predicted characteristics of water movement or waves in the water column to achieve resonance and thereby maximize energy capture. For example, to maximize mechanical power production, the dimensions of the fluid channel 340 and the fluid level 351 of the undisturbed working fluid 342 may be designed such that the flow of the working fluid 342 remains laminar for the probable wave climate (i.e., probable significant wave height and probable wave energy period), while avoiding or minimizing chaotic sloshing or sloshing wave breaking. Additionally, the fluid channel 340 may be designed such that the natural period of motion of the working fluid 342 is close to the probable wave energy period. Further, the design of the fluid channel 340 may be optimized to minimize the levelized cost of energy.

As previously described, the arms 332 of mounting assembly 330 are pivotably connected to the housing 320 (not shown in FIG. 14) of the WEC 300 by the pivot joint 334. The mounting assembly 330 allows housing 320 of the WEC 300 to be mounted or rigidly coupled to a marine structure (e.g., surface support structure 14 of FIG. 1) while permitting the WEC 300 to rotate about a pivot axis 325 extending centrally through and defined by the pivot joint 334.

Referring briefly to FIGS. 15 and 16, orientation of the WEC 300 as it encounters water movement or incoming waves in the water column is shown. Particularly FIG. 15 shows movement or sloshing motion of the working fluid 342 in the direction of a first wave (indicated by arrow A in FIG. 15) and towards a first or lower end 341 of the fluid channel 340 as an upper end 349 of the fluid channel 340 is being lifted when the first wave A approaches the WEC 300, thereby causing an increase in the fluid level 351 at the lower end 341 and a decrease in the fluid level 351 at the upper end 349 of the fluid channel 340. However, as the working fluid 342 sloshes to the lower end 341, it creates a counteracting force indicated by arrow 353 in FIG. 15 together with the buoyancy of the WEC housing itself, causing the working fluid 342 to move back and forth in the fluid channel 340 as it seeks equilibrium. The back and forth movement or sloshing action of the working fluid 342 induces rotational motion in the blades of the turbine disposed in the horizontal channel 346 and in contact with the working fluid 342, converting the kinetic energy of the waves in the water column into rotational mechanical energy.

FIG. 16 shows movement or sloshing motion of the working fluid 342 in the direction of a second wave (indicated by arrow B in FIG. 16) and towards the second or upper end 349 of the fluid channel 340 as the first or lower end 341 of the fluid channel 340 is being lifted when the second wave B approaches the WEC 300, thereby causing an increase in the fluid level 351 at the upper end 349 and a decrease in the fluid level 351 at the lower end 341 of the fluid channel 340. As previously described, as the working fluid 342 sloshes to the upper end 349, it creates a counteracting force indicated by arrow 357 in FIG. 16, together with the buoyancy of the WEC housing itself, causing the working fluid 342 to move back and forth in the fluid channel 340 as it seeks equilibrium. The back and forth movement or sloshing action of the working fluid 342 induces rotational motion in the blades of the turbine disposed in the horizontal channel 346 and in contact with the working fluid 342, converting the kinetic energy of the waves in the water column into rotational mechanical energy.

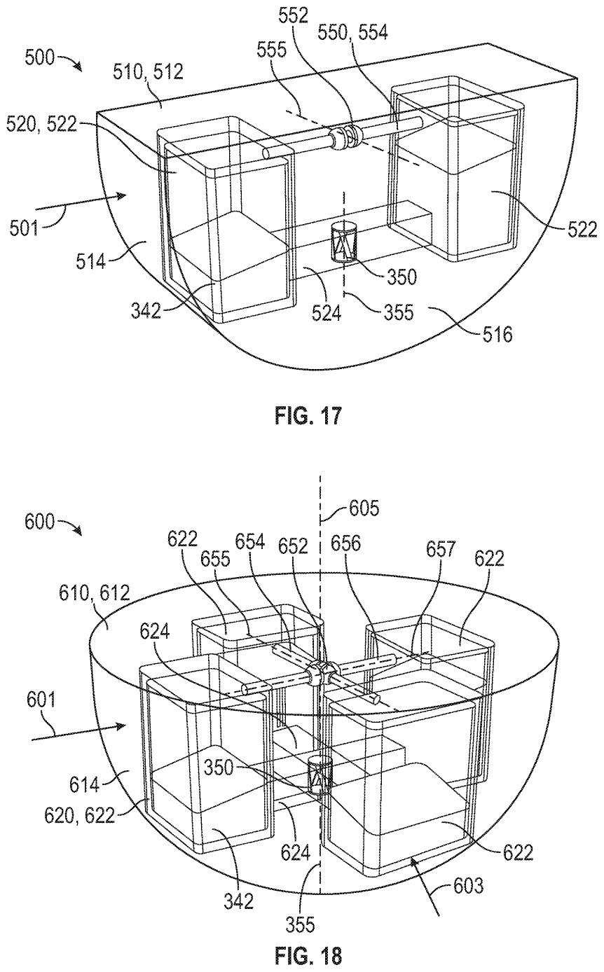

Referring to FIG. 17, another embodiment of a WEC 500 is shown. WEC 500 may include features in common with the WEC 300 shown in FIG. 12, and shared features are labeled similarly. In this exemplary embodiment, WEC 500 generally includes an outer shell or housing 510, turbine 350, and an electrical generator (not shown in FIG. 17) which, in some embodiments, may be similar in configuration to the electrical generator 360 shown in FIG. 12. Housing 510 has a generally U-shaped cross-section in this exemplary embodiment and includes an upper surface 512, a curved, convex or parabolic lower surface 514 that extends to and terminates at opposing longitudinal ends of upper surface 512, and a pair of lateral or side surfaces 516 each extending between the upper surface 512 and lower surface 514.

Housing 510 of the WEC 500 is defined by an interior comprising a generally U-shaped fluid channel 520 that is sealed from the surrounding environment (e.g., from the water column). Fluid channel 520 includes a pair of vertical channels 522 and a horizontal channel 524 within which the turbine 350 is positioned along and that fluidically connects the pair of vertical channels 522 at lower ends thereof. The U-shaped tube provides a flow path for working fluid 342 contained therein while allowing changes in the direction of fluid flow in the fluid channel 340, such as in a sloshing motion of liquid contained therein, in response to rotation of housing 510. Particularly, the working fluid 342 fills the horizontal channel 524 and partially fills each of the vertical channels 522 with the amount of working fluid 342 contained in each vertical channel 522 varying depending on the angular orientation of housing 510.

FIG. 17 additionally shows a mounting assembly 550 for pivotably connecting the WEC to a marine structure and which includes a pivot joint or connector 552 and a connector member 554 coupled to the pivot connector 552. Connector member 554 connects the housing 510 (e.g., at a position along upper surface 512 positioned equidistantly between opposing ends of upper surface 512) to the pivot connector 552 whereby the WEC 500 is pivotable about a horizontally extending pivot axis 555. In some embodiments, mounting assembly 550 comprises the second pivot connector 268 and connector member 270 shown in FIG. 8; however, in other embodiments, mounting assembly 550 may vary in configuration from the mounting assembly 260 shown in FIG. 8.

In this exemplary embodiment, the pivot axis 555 extends orthogonal longitudinal axes of vertical channels 522. Additionally, in this exemplary embodiment, turbine 350 is oriented within horizontal channel 524 such that turbine axis 355 extends vertically-parallel the longitudinal axes of vertical channels 522 and orthogonal to the pivot axis 555. However, the orientation of turbine axis 355 may vary in other embodiments. WEC 500 is configured to pivot or oscillate about pivot axis 555 in response to wave energy applied against the lower surface 514 (indicated by arrow 501 in FIG. 17). In turn, pivoting about pivot axis 555 by WEC 500 induces oscillatory or cyclical flow of working fluid 342 through the horizonal channel 524 to rotate the turbine 350 about turbine axis 355.

In some applications, the curved shape of the lower surface 514 of the housing 510 of WEC 500 may reduce the amount of fluid drag incurred by the WEC 500 during operation relative to the configuration of housing 320 of WEC 300 shown in FIG. 12. In addition, the shape of housing 510 may increase wave-induced excitations in the pivoting of WEC 500 about pivot axis 555. Thus, in some applications, the shape of housing 510 of WEC 500 may offer increased hydrodynamic performance relative to other embodiments in some applications.

Referring to FIG. 18, another embodiment of a WEC 600 is shown. WEC 600 may include features in common with the WEC 300 shown in FIG. 12, and shared features are labeled similarly. In this exemplary embodiment, WEC 600 generally includes an outer shell or housing 610, turbine 350, and an electrical generator (not shown in FIG. 17) which, in some embodiments, may be similar in configuration to the electrical generator 360 shown in FIG. 12. Housing 610 includes a generally disc-shaped upper surface 612 and a curved, hemispherical or ellipsoidal lower surface 614 that extends to and terminates at an outer periphery or diameter of upper surface 612.

Additionally, housing 610 of the WEC 600 is defined by an interior comprising a pair of generally U-shaped fluid channels 620 that are sealed from the surrounding environment (e.g., from the water column). Particularly, fluid channels 620 are spaced approximately ninety degrees about a central axis 605 of WEC 600. Each fluid channel 620 includes a pair of vertical channels 622 and a horizontal channel 624 that fluidically connects the pair of vertical channels 622 at lower ends thereof. Horizontal channels 624 may intersect at a location spaced equidistantly from opposing ends thereof, with the turbine 350 positioned within the pair of horizontal channels 624 at the point where they intersect within the housing 610. Additionally, turbine 350 is oriented such that turbine axis 355 extends orthogonal both horizontal channels 624 such that flow of working fluid 342 through either of horizontal channels 624 drives rotation of turbine 350 about turbine axis 355.

FIG. 18 additionally shows a mounting assembly 650 for pivotably connecting the WEC to a marine structure and which includes a pivot joint or connector 652 and a pair of connector members 654 and 656 coupled to the pivot connector 652 and which extend orthogonally relative to each other. Connector members 654 and 656 both connect the housing 610 (e.g., at a position along upper surface 612 located along central axis 605) to the pivot connector 552 whereby the WEC 500 is pivotable about separate horizontally extending pivot axes 655 and 657, respectively. Particularly, WEC 600 is pivotable about both a first pivot axis 655 and a second pivot axis 657 that extends orthogonal relative to the first pivot axis 655.

By providing orthogonal pivot axes 655 and 657, WEC 600 may drive the rotation of turbine 350 about turbine axis 355 to thereby generate electrical energy or power irrespective of the direction of the wave energy directed against the lower surface 614 of housing 610. For example, waves directed in a first direction 601 excite oscillation of the WEC 600 about the first pivot axis 655 whereby working fluid 342 flows cyclically back-and-forth through a first horizontal channel 624 to drive rotation of turbine 350 about turbine axis 355. Similarly, waves directed in a second direction 603 that is orthogonal to the first direction 601 (e.g., spaced ninety degrees from the first direction 601 about central axis 605) excite oscillation of the WEC 600 about the second pivot axis 657 whereby working fluid 342 flows cyclically back-and-forth through a second horizontal channel 624 to drive rotation of turbine 350 about turbine axis 355. In this manner, a greater amount of electrical energy or power may be extracted from wave energy given that waves can travel in multiple directions when impacting the WEC 600.

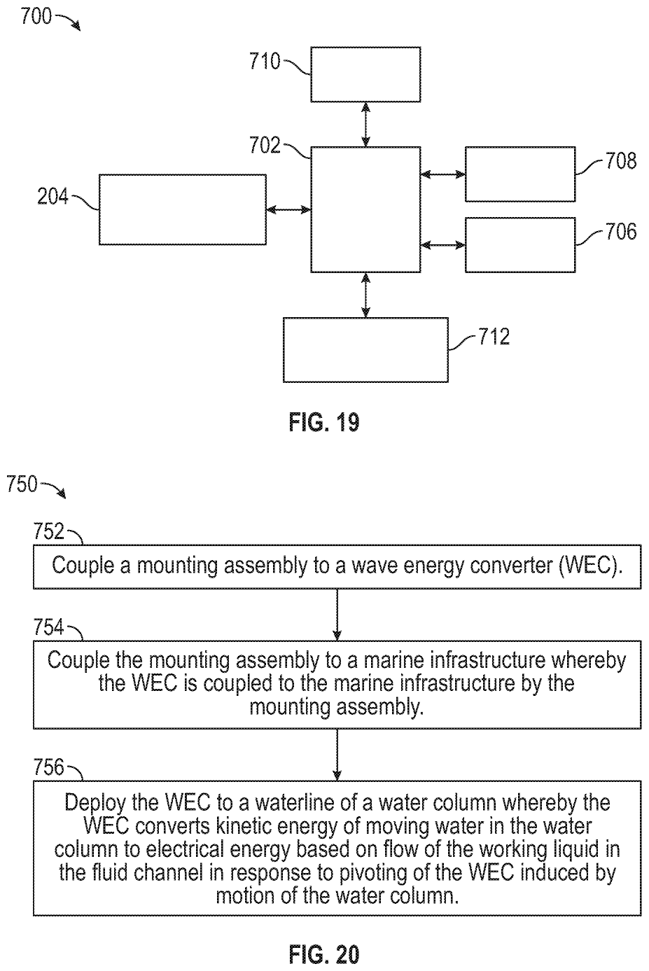

Referring to FIG. 19, a block diagram of an embodiment of an exemplary computer system 700 in accordance with principles disclosed herein is shown. For example, the controller of the control device described in FIGS. 2 and 3 and/or the system controller 290 shown in FIG. 7 may comprise the computer system 700 or may incorporate at least some of the features of computer system 700. The computer system 700 of FIG. 19 includes a processor 702 (which may be referred to as a central processor unit or CPU) that is in communication with memory devices including secondary storage 704, read only memory (ROM) 706, random access memory (RAM) 708, input/output (I/O) devices 710, and network connectivity devices 712. The processor 702 may be implemented as one or more CPU chips. It is understood that by programming and/or loading executable instructions onto the computer system 700, at least one of the CPU 702, the RAM 708, and the ROM 706 are changed, transforming the computer system 700 in part into a particular machine or apparatus having the novel functionality taught by the present disclosure.

Additionally, after the system 700 is turned on or booted, the CPU 702 may execute a computer program or application. For example, the CPU 702 may execute software or firmware stored in the ROM 706 or stored in the RAM 708. In some cases, on boot and/or when the application is initiated, the CPU 702 may copy the application or portions of the application from the secondary storage 704 to the RAM 708 or to memory space within the CPU 702 itself, and the CPU 702 may then execute instructions that the application is comprised of. In some cases, the CPU 702 may copy the application or portions of the application from memory accessed via the network connectivity devices 712 or via the I/O devices 710 to the RAM 708 or to memory space within the CPU 702, and the CPU 702 may then execute instructions that the application is comprised of. During execution, an application may load instructions into the CPU 702, for example load some of the instructions of the application into a cache of the CPU 702. In some contexts, an application that is executed may be said to configure the CPU 702 to do something, e.g., to configure the CPU 702 to perform the function or functions promoted by the subject application. When the CPU 702 is configured in this way by the application, the CPU 702 becomes a specific purpose computer or a specific purpose machine.

Secondary storage 704 may be used to store programs which are loaded into RAM 708 when such programs are selected for execution. The ROM 706 is used to store instructions and perhaps data which are read during program execution. ROM 706 is a non-volatile memory device which typically has a small memory capacity relative to the larger memory capacity of secondary storage 704. The secondary storage 704, the RAM 708, and/or the ROM 706 may be referred to in some contexts as computer readable storage media and/or non-transitory computer readable media. I/O devices 710 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 712 may take the form of modems, modem banks, Ethernet cards, universal serial bus (USB) interface cards, wireless local area network (WLAN) cards, radio transceiver cards, and/or other well-known network devices. The network connectivity devices 712 may provide wired communication links and/or wireless communication links. These network connectivity devices 712 may enable the processor 702 to communicate with the Internet or one or more intranets. With such a network connection, it is contemplated that the processor 702 might receive information from the network, or might output information to the network. Such information, which may include data or instructions to be executed using processor 702 for example, may be received from and outputted to the network, for example, in the form of a computer data baseband signal or signal embodied in a carrier wave.

The processor 702 executes instructions, codes, computer programs, scripts which it accesses from hard disk, floppy disk, optical disk, flash drive, ROM 706, RAM 708, or the network connectivity devices 712. While only one processor 702 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 704, for example, hard drives, floppy disks, optical disks, and/or other device, the ROM 706, and/or the RAM 708 may be referred to in some contexts as non-transitory instructions and/or non-transitory information.

In an embodiment, the computer system 700 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, the functionality disclosed above may be provided by executing the application and/or applications in a cloud computing environment. Cloud computing may comprise providing computing services via a network connection using dynamically scalable computing resources.

Referring to FIG. 20, an embodiment of a method 750 for wave energy extraction is shown. Method 750 begins at block 752 with coupling a mounting assembly to a wave energy converter (WEC). As previously described, the WEC comprises a housing defined by an interior with a fluid channel having a working fluid (e.g., water) positioned in the interior. In some embodiments, the mounting assembly comprises one or more support arms coupled to the housing and is pivotably connected to the housing by a pivot joint permitting the housing to rotate about a pivot axis of the pivot joint.

At block 754, method 750 continues with coupling the mounting assembly to a marine structure whereby the WEC is coupled to the marine structure by the mounting assembly. The marine structure may comprise a breakwater, a wind turbine, and a hydrocarbon platform. In some embodiments, the WEC may be lifted and/or lowered using the mounting assembly, in response to changing environmental and operational conditions. Method 750 continues at block 756 with deploying the WEC to a waterline of a water column such that the WEC floats on the surface of the water column. Additionally, at block 754, kinetic energy of moving water in the water column is converted by the WEC to electrical energy based on flow of the working fluid in the fluid channel in response to rotation of the housing, which is induced by motion in the water column. As previously described, a turbine is disposed in the fluid channel of the WEC and in direct contact with the working fluid. As the working fluid sloshes around the turbine in response to water movement or wave action acting on the WEC, the sloshing movement causes the blades of the turbine to rotate, converting the kinetic energy of the waves or water column into rotational mechanical energy, which may be converted to electrical power by a generator coupled to the turbine.

While embodiments of the disclosure have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A floating wave energy converter (WEC) comprising:
a floating housing defined by an interior;
a fluid channel positioned in the interior and configured to hold a working fluid; and
a turbine positioned along the fluid channel to contact the working fluid when the working fluid is held in the fluid channel, and wherein in response to a movement in a water column external the WEC, motion is induced in the working fluid to operate the turbine and generate electrical energy.

2. The WEC of claim 1, wherein the fluid channel is sealed from the water column.

3. The WEC of claim 2, wherein the fluid channel comprises a plurality of vertical channels extending between a vertically upper end and a longitudinally opposed vertically lower end, and a horizontal channel fluidically connecting the plurality of vertical channels.

4. The WEC of claim 3, wherein the working fluid is allowed to flow between the plurality of vertical channels in multiple directions.

5. The WEC of claim 4, wherein the plurality of vertical channels are configured to induce a back-and-forth flow of the working fluid through the horizontal channel in response to rotation of the WEC about a pivot axis.

6. The WEC of claim 1, wherein a natural frequency of the floating housing is configured to align with a natural frequency of the water column.

7. The WEC of claim 1, wherein the housing comprises a hemispherical or an ellipsoidal lower surface.

8. The WEC of claim 1, wherein the housing comprises a convex lower surface.

9. The WEC of claim 1, wherein the fluid channel comprises a first pair of vertical channels, a first horizontal channel fluidically connected between the first pair of parallel vertical channels, a second pair of vertical channels, and a second horizontal channel fluidically connected between the second pair of parallel vertical channels and extending orthogonal to the first horizontal channel such that the second horizontal channel intersects the first horizontal channel.

10. The WEC of claim 1, further comprising a pivot connector, a first connector member pivotably connecting the housing to the pivot connector whereby the WEC is pivotable about a first pivot axis defined by the pivot connector, and a second connector member pivotably connecting the housing to the pivot connector whereby the WEC is pivotable about a second pivot axis defined by the pivot connector that extends orthogonal to the first pivot axis.

11. A system for wave energy extraction, the system comprising:
a floating wave energy converter (WEC) comprising:
a floating housing defined by an interior;
a fluid channel positioned in the interior and configured to hold a working fluid;
a turbine positioned along the fluid channel and in contact with the working fluid when the working fluid is held by the fluid channel, wherein the turbine is configured to generate electrical energy in response to flow of the working fluid through the fluid channel driven by pivoting of the WEC about a pivot axis; and
a mounting assembly configured to couple the WEC to a marine structure.

12. The system of claim 11, wherein the mounting assembly comprises one or more support arms pivotably connected to the housing by a pivot connector whereby the WEC is rigidly secured to the marine structure while allowing the WEC to rotate about a pivot axis of the pivot connector.

13. The system of claim 11, wherein the fluid channel comprises a pair of parallel vertical channels extending between a vertically upper end and a longitudinally opposed vertically lower end, and a horizontal channel fluidically connecting the pair of vertical channels.

14. The system of claim 11, wherein the mounting assembly comprises a linear actuator configured to transport the WEC between a deployed position and a retracted position that is vertically spaced from the deployed position.

15. The system of claim 11, wherein the mounting assembly comprises a vertical rail, an elevator transportable along the rail, and a mount coupled between the WEC and the elevator.

16. The system of claim 15, further comprising a linear actuator configured to transport the elevator vertically along the rail, and a system controller comprising one or more processors and a memory device encoded with instructions that, when executed by the one or more processors, cause the one or more processors to operate the linear actuator to transport the WEC between a deployed position and a retracted position that is vertically spaced from the deployed position.

17. The system of claim 15, wherein the elevator comprises a locking pin actuatable between a retracted position permitting relative movement between the rail and the elevator and an extended position locking the elevator to the rail.

18. A method for wave energy extraction, the method comprising:
(a) coupling a mounting assembly to a wave energy converter (WEC), the WEC comprising a floating housing defined by an interior, wherein a fluid channel having a working fluid is positioned in the interior;
(b) coupling the mounting assembly to a marine structure whereby the WEC is coupled to the marine structure by the mounting assembly; and
(c) deploying the WEC to a waterline of a water column whereby the WEC converts kinetic energy of moving water in the water column to electrical energy based on flow of the working fluid in the fluid channel in response to pivoting of the WEC induced by motion of the water column.

19. The method of claim 18, wherein the mounting assembly is pivotably connected to the housing by a pivot joint permitting the housing to rotate about a pivot axis of the pivot joint.

20. The method of claim 18, wherein the WEC is pivotably coupled to the marine structure by the mounting assembly whereby the WEC is pivotable about both a first pivot axis and a second pivot axis that extends orthogonal to the first pivot axis.

21. The method of claim 18, further comprising
(d) transporting the WEC vertically by the mounting assembly, in response to changing environmental and operational conditions.

22. The method of claim 18, further comprising:
(d) vertically transporting the WEC by the mounting assembly between a deployed position at the waterline and a retracted position located vertically above the waterline and spaced from the deployed position.
